(19) United States
(12) Patent Application Publication
(10) Pub. No.: US 2006/0082837 A1
(43) Pub. Date: Apr. 20, 2006

(54) Image processing apparatus

(75) Inventors: Yoshihito Hiroe, Tagata-gun (JP); Naoya Murakami, Yokohama-shi (JP); Masami Taoda, Fuchu-shi (JP); Kouichi Watanabe, Kawasaki-shi (JP); Eiichi Yamanishi, Yokohama-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/253,759

(22) Filed: Oct. 20, 2005

(30) Foreign Application Priority Data
Oct. 20, 2004 (JP) 2004-306164

(51) Int. Cl. H04N 1/40

(52) U.S. Cl. 358/448

(57) ABSTRACT

There is disclosed an image processing apparatus in which a control section selects an image processing program to be executed for image data input by an image input section and the program selected by the control section is set in a digital signal processing section. According to the image processing apparatus of this state, when the image data is input by the image input section, the digital signal processing section having the program selected by the control section set therein processes the image data input by the image input section.

### CROSS-REFERENCE TO RELATED APPLICATIONS

This application is based upon and claims the benefit of priority from prior Japanese Patent Application No. 2004-306164, filed Oct. 20, 2004, the entire contents of which are incorporated herein by reference.

### BACKGROUND OF THE INVENTION

1. Field of the Invention

The present invention relates to an image processing apparatus such as a digital compound machine which processes image data input from, e.g., a scanner, an external device, or the like, prints the processed image data, stores the data in a memory or outputs the data to the external device.

2. Description of the Related Art

Conventionally, in the image processing apparatus such as a digital compound machine, various kinds of image processing have been carried out for image data read by the scanner or received from the external device. For example, to copy a document image with high accuracy at a high speed, complex image processing must be carried out for the image data read by the scanner. Such complex image processing requires high processing efficiency. In the conventional digital compound machine, the image processing for the image data has been realized by using dedicated hardware such as an ASIC.

However, it takes a long time to develop the hardware such as an ASIC for realizing the complex image processing. A long time is also necessary from an algorithm development to product application. Consequently, a latest image processing algorithm cannot be applied to the digital compound machine as a product in some cases. In other words, a long designing time and enormous development costs are necessary for the hardware such as an ASIC for realizing the complex image processing. Accordingly, when a problem occurs to necessitate an algorithm change after formation of the ASIC, an ASIC must be formed again. Even in such a case, an ASIC development must be performed long before the digital compound machine is manufactured. In reality, therefore, a problem of impossible mounting of the latest algorithm on the digital compound machine may occur. Additionally, in the digital compound machine in which the image processing is realized by the hardware such as an ASIC, there is a problem of a limited scope of meeting market demands or satisfying user's claims after the manufacturing.

### BRIEF SUMMARY OF THE INVENTION

It is an object of the present invention to provide an image processing apparatus flexible enough to easily mount new processing at low costs.

According to an aspect of the present invention, an image processing apparatus comprises an image input section which inputs image data, a control section which selects a program to execute image processing for the image data input by the image input section, and a digital signal processing section in which the program selected by the control section is set and which processes the image data input by the image input section by the set program.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram schematically showing a digital compound machine as an image processing apparatus and a configuration of an image processing system according to this embodiment;

FIG. 2 is a diagram showing an example of an operation of copying a monochromatic image;

FIG. 3 is a diagram showing an appearance configuration of a 3-line CCD sensor used as a scanner CCD sensor;

FIG. 4 is a diagram showing an appearance configuration of a 4-line CCD sensor used as a scanner CCD sensor;

FIG. 5 is a diagram showing an example of a plurality of processing operations executed in parallel by a DSP;

FIG. 6 is a diagram showing a configuration example of a user interface;

FIG. 7 is a flowchart illustrating an operation of setting a program in the DSP;

FIG. 8 is a diagram showing addressing in 2-dimensional arrangement when image data of a raster format from a scanner is written in a memory;

FIG. 9 is a diagram showing an example of a method of accessing an external memory by the DSP;

FIG. 10 is a diagram showing an example of a method of accessing the external memory by the DSP;

FIG. 11 is a diagram showing a sequence of writing image data read from the external memory by the DSP in an internal memory;

FIG. 12 is a diagram showing a sequence of reading the image data stored in the internal memory of the DSP;

FIG. 13 is a flowchart illustrating an operation of setting an image processing program of an encrypted state in the DSP;

FIG. 14 is a diagram illustrating processing for setting the program of the encrypted state in the DSP;

FIG. 15 is a diagram illustrating processing by a decrypted state in the DSP; and

FIG. 16 is a diagram illustrating processing for deleting the program from the DSP.

### DETAILED DESCRIPTION OF THE INVENTION

Hereinafter, the preferred embodiment of the present invention will be described with reference to the accompanying drawings.

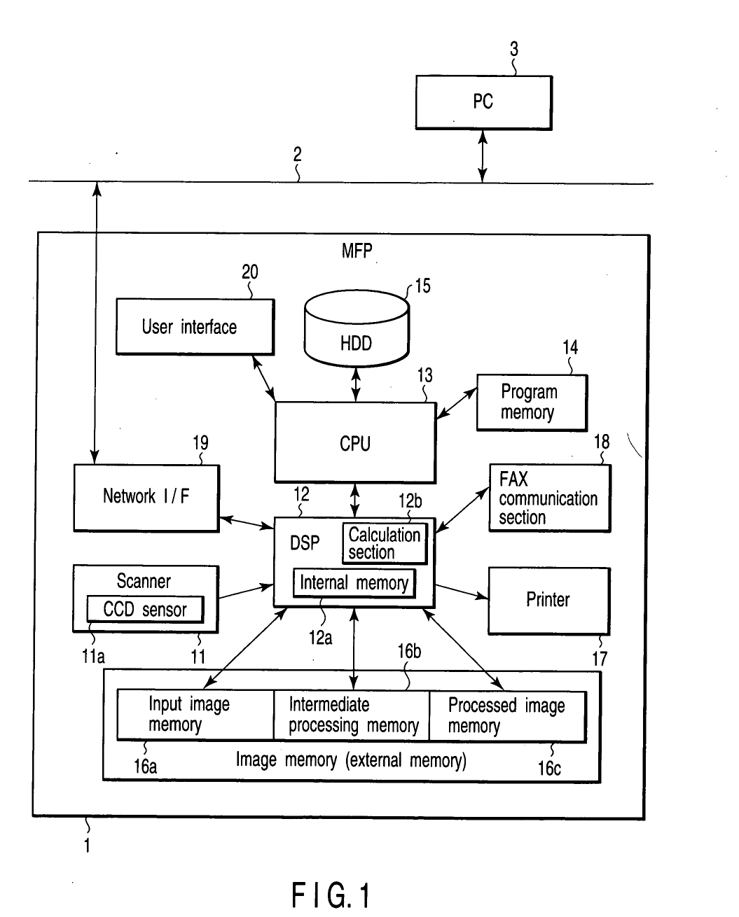

FIG. 1 schematically shows a digital compound machine (MFP) 1 as an image processing apparatus and a configuration of an image processing system according to this embodiment.

Referring to FIG. 1, the image processing system is configured by connecting the digital compound machine 1 as the image processing apparatus to a personal computer (PC) 3 through a network 2. According to this image processing system, data such as image data can be transferred between the digital compound machine 1 and the PC 3 through the network 2.

As shown in FIG. 1, the digital compound machine 1 is constituted of a scanner 11, a digital signal processor (DSP) 12, a CPU 13, a program memory 14, a hard disk drive (HDD) 15, an image memory 16, a printer 17, a FAX communication section 18, a network interface (network I/F) 19, a user interface (UI) 20, and the like.

The scanner 11 converts a document image into image data. The scanner 11 functions as an image input section for inputting image data. For example, the scanner 11 optically reads an image of a document to convert it into a digital signal, thereby reading the document image as image data. The scanner 11 has a CCD sensor 11a for converting a light from the document image into a digital signal of each pixel image. For example, the CCD sensor 11a is constituted of a line sensor of one line in one or a plurality of main scanning directions. In this case, the scanner 11 optically scans the document image sequentially in a sub-scanning direction. Accordingly, the CCD sensor 11a of the scanner 11 sequentially inputs image data of one line in the main scanning direction.

The DSP 12 is constituted of an LSI for processing a digital signal. The DSP 12 functions as a digital signal processing section to execute various processing operations. According to the embodiment, the DSP 12 is used for executing various image processing operations. Various image processing operations executed by the DSP 12 are realized by programs set by the CPU 13. An internal memory 12a and a calculation section 12b are disposed in the DSP 12. The internal memory 12a stores the programs set by the CPU 13 or image data. The calculation section 12b executes the programs set in the internal memory 12a. As a result, in the DSP 12, the programs stored in the internal memory 12a are executed by the calculation section 12b to realize various processing operations.

The CPU 13 is in charge of control of the entire digital compound machine 1. The CPU 13 controls or sets an operation of each section in the digital compound machine 1. For example, the CPU 13 has a function of setting one or a plurality of programs for the DSP 12. In this case, the CPU 13 functions as a control section for setting (switching, changing) an image processing function or the like realized by the DSP 12. The program memory 14 stores various image processing programs executed by the DSP 12 in addition to various programs executed by the CPU 13. The HDD 15 stores image data or the like, and stores various, image processing programs executed by the DSP 12.

With this configuration, the CPU 13 determines processing to be executed by the DSP 12 in accordance with processing contents to be executed. Further, based on the determination, the CPU 13 reads a program corresponding to the processing to be executed by the DSP 12 from the program memory 14 or the HDD 15 to set it in the DSP 12.

The image memory 16 has an input image memory (storage area of input image data) 16a, an intermediate processing memory (storage area of image data being processed) 16b, and a processed image memory (storage area of output image data) 16c. The input image memory 16a temporarily stores image data read by the scanner 11 or image data input through the network interface 19. The intermediate processing memory 16b temporarily stores image data (intermediate data) being processed by the DSP 12. The processed image memory 16c stores image data whose processing by the DSP 12 has been completed. For example, the processed image memory 16c stores image data output to the printer 17.

The memories 16a to 16c are used when necessary. For example, when the image data input by the scanner 11 or the like is printed in its state by the printer 17 (image processing by the DSP 12 is unnecessary), the input image data is stored in the memory 16c. With this processing, printing can be carried out by using the memory 16c alone.

The printer 17 forms an image in an image forming medium based on the image data. The printer 17 functions as an image forming section. For example, the printer 17 executes image forming processing based on image data whose processing by the DSP 12 has been finished. In this case, it is presumed that the printer 17 has a function of forming a color image based on color image data (color print function) or a function of forming a monochromatic image based on monochromatic image data (monochromatic print function). The printer 17 operates selectively as a color printer or a monochrome printer under control of the CPU 13.

The FAX communication section 18 is an interface for transferring facsimile data with an external device (not shown). The FAX communication section 18 functions as an input or output section of image data. The network interface 19 communicates data with each device such as the PC 3 on the network 2 through the same. The network interface 19 also functions as an input or output section of image data.

The user interface (UI) 20 includes an operation panel constituted of, e.g., a liquid crystal display with a built-in touch panel, a hard key, and the like. The user interface 20 receives an operation instruction input from a user. The user interface 20 functions as an operation section. The user interface 20 has a start key for instructing a start of processing, and operation keys for setting various operations. For example, when the user inputs operation setting by various operation keys and inputs the start key, the digital compound machine 1 executes an operation instructed by the user.

Next, description will be made of a program set by the CPU 13 for the DSP 12 in the digital compound machine 1 thus configured.

In the digital compound machine 1, the CPU 13 changes the program set in the DSP 12 in accordance with processing contents. The program set for the DSP 12 by the CPU 13 is stored in the program memory 14 or the HDD 15.

That is, the CPU 13 determines image processing to be executed by the DSP 12 in accordance with the processing contents. The CPU 13 reads a program corresponding to the determined image processing from the program memory 14 or the HDD 15 to set it in the DSP 12. Accordingly, in the DSP 12, the program for executing image processing compliant with the processing contents is properly set.

When the digital compound machine 1 copies a document image, for example, the CPU 13 determines preparation processing, filter processing, magnification conversion, density conversion, γ conversion, error diffusion conversion, dither processing, or the like as image processing to be executed by the DSP 12. In this case, the CPU 13 selectively reads a program of the preparation processing, the filter processing, the magnification conversion, the density conversion, the γ conversion, the error diffusion processing, the dither processing, or the like from the program memory 14 or the HDD 15 to set it for the DSP 12. As a result, in the DSP 12, the image processing program to be executed for copying (program for creating printing image data from scanned image) is set.

When the digital compound machine 1 transmits FAX, for example, the CPU 13 determines preparation processing, filter processing, magnification conversion, density conversion, error diffusion conversion, or the like as image processing to be executed by the DSP 12. In this case, the CPU 13 selectively reads a program of the preparation processing, the filter processing, the magnification conversion, the density conversion, the error diffusion processing, or the like from the program memory 14 or the HDD 15 to set it for the DSP 12. As a result, in the DSP 12, the image processing program to be executed for FAX transmission (program for creating FAX transmission data) is set.

When the digital compound machine 1 reads a document image, for example, the CPU 13 determines preparation processing, filter processing, magnification conversion, density conversion, error diffusion conversion, or the like as image processing to be executed by the DSP 12. In this case, the CPU 13 selectively reads a program of the preparation processing, the filter processing, the magnification conversion, the density conversion, the error diffusion processing, or the like from the program memory 14 or the HDD 15 to set it for the DSP 12. As a result, in the DSP 12, the image processing program to be executed for document data reading (program for creating scan data) is set.

As described above, the image processing to be executed by the DSP 12 is set by the CPU 13 in accordance with the processing contents. Thus, the image processing executed by the DSP 12 can be switched in accordance with processing contents or the like as occasion demands, whereby efficient image processing can be realized. The DSP 12 can perform various image processing operations in accordance with programs set by the CPU 13. As a result, the digital compound machine can provide a variety of low-cost processing operations.

Furthermore, the image processing programs set in the DSP 12 are stored in the rewritable program memory 14 or HDD 15. Accordingly, even after the digital compound machine is manufactured, the image processing programs can be easily rewritten or added, whereby a flexible digital compound machine can be provided.

Next, an operation example of the digital compound machine 1 thus configured will be described. In this case, an example of a copying operation will be described as the operation example of the digital compound machine 1.

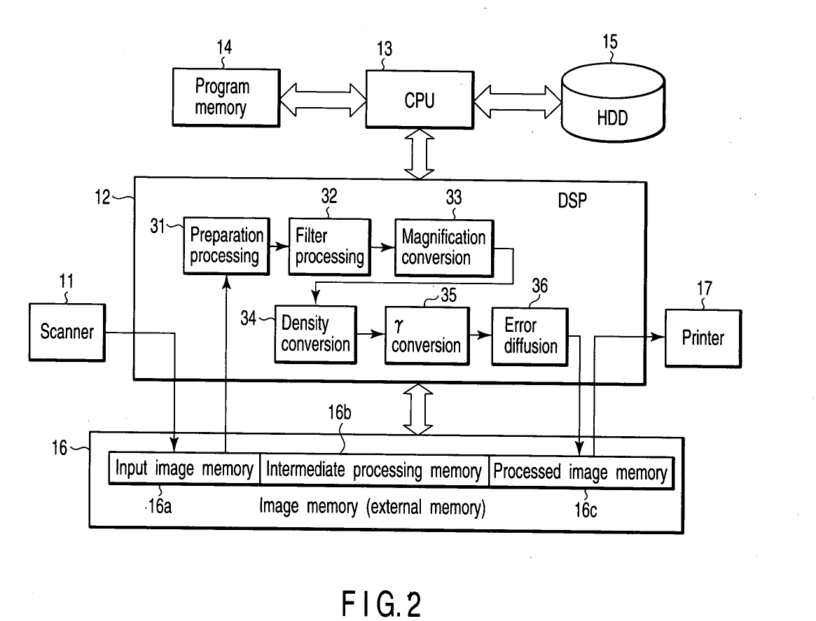

FIG. 2 illustrates an example of a copying operation of a monochromatic image.

First, the CPU 13 sets an image processing program to be executed by the DSP 12. That is, for example, the CPU 13 determines contents of image processing to be executed for the image data read by the scanner 11 in accordance with processing contents selected by the user. In this case, the CPU 13 reads the program of image processing determined to be executed from the program memory 14 or the HDD 15, and sets the program for the DSP 12.

When an operation of copying monochromatic image data is performed, for example, the CPU 13 determines preparation processing, filter processing, magnification conversion processing, density conversion (density adjustment) processing, γ conversion (γ adjustment) processing, error diffusion processing (or dither processing), or the like to be executed for the image data read by the scanner 11. In this case, as shown in FIG. 2, the CPU 13 reads a program of the preparation processing 31, the filter processing 32, the magnification conversion processing 33, the density conversion (density adjustment) processing 34, the γ conversion (γ adjustment) processing 35, the error diffusion processing 36 (or dither processing), or the like from the program memory 14 or the HDD 15 to set it for the DSP 12.

The setting of the program for the DSP 12 by the CPU 13 only needs to be completed before the DSP 12 executes image processing. For example, the setting of the program for the DSP 12 by the CPU 13 may be executed at a point of time when the start key of the user interface 20 is input (processing contents are established), or for each inputting of various operation keys. Timing of setting the program for the DSP 12 by the CPU 13 will be described later by a specific example.

The scanner 11 optically scans a document mounted on a document base glass (not shown) or a document image conveyed by an automatic document feeder (ADF) to convert it into a digital signal. That is, the scanner 11 optically scans the document image in a sub-scanning direction to sequentially input image data as image valid signals output from the CCD sensor 11a installed in a main scanning direction to the DSP 12. For example, the image data output from the scanner 11 to the DSP 12 is image data of a raster format synchronized with a sub-scanning direction valid signal (VDEN) and a main scanning direction valid signal (HDEN).

The image data from the scanner 11 is stored in the input image memory 16a. The image data from the scanner 11 may be directly stored in the input image memory 16a without any passage through the DSP 12.

Upon storage of the image data from the scanner in the input image memory 16a, the DSP 12 executes image processing for the image data stored in the input image memory 16a by the program set by the CPU 13.

In this case, as shown in FIG. 2, the preparation processing 31, the filter processing 32, the magnification conversion processing 33, the density conversion (density adjustment) processing 34, the γ conversion (γ adjustment) processing 35, and the error diffusion processing 36 have been set in the DSP 12 to perform the copying operation of the monochromatic image. Accordingly, the DSP 12 sequentially executes preparation processing, filter processing, magnification conversion processing, density adjustment processing, γ adjustment processing, and error diffusion processing for the image data stored in the input image memory 16a (image data input from the scanner), and the processed image data is stored in the processed image memory 16c.

The processed image data stored in the processed image memory 16c is synchronized with main and sub scanning synchronous signals (HYSNC, VSYNC) from the printer 17 to be output as printing data of a raster format to the printer 17. As a result, the printer 17 prints an image based on the image data stored in the processed image memory 16c on copy paper.

For the image data input to the DSP 12 from the scanner 11, the DSP 12 may start image processing within a range capable of guaranteeing an input rate of the image data as occasion demands. In other words, in the middle of storing the image data input from the scanner 11 in the input image memory 16a (without waiting for storage completion of the image data in the input image memory 16a), the DSP 12 may start the image processing. Hence, it is possible to achieve a high speed for the operation of the entire digital compound machine 1.

The DSP 12 may directly process the image data from the scanner 11 without using the input image memory 16a. In this case, the DSP 12 processes the image data sequentially input from the scanner 11 into desired formats within the range capable of guaranteeing the image data input rate. The image data obtained by directly processing such input image data may be stored in the input image memory 16a or the intermediate processing memory 16b. For example, color conversion processing for a color image from the scanner 11 can be directly executed by the DSP 12 without using the memory 16.

In image processing such as filter processing executed by the DSP 12 which requires reference to data of plural lines, a memory must be provided to enable reference to the data of the lines at a high speed. Generally, for a speed of accessing the memory, accessing is faster in the case of the internal memory 12a of the DSP 12 than in the case of the image memory (external memory) 16 connected to the outside of the DSP 12. A freedom of memory addressing is higher in the internal memory 12a than in the image memory 16 as the external memory of the DSP 12.

Thus, the internal memory 12a is preferably used for image processing in the DSP 12. However, when a storage capacity (size of usable memory area) of the internal memory 12a in the DSP 12 is not enough for image processing, the DSP 12 uses the image memory (e.g., intermediate processing memory 16b) 16 as the external memory to execute the image processing.

Next, description will be made of a configuration example of the digital compound machine 1 as an image processing apparatus which has functions of processing monochromatic and color images.

A basic configuration of the digital compound machine that has the functions of processing monochromatic and color images (e.g., monochrome and color copy functions) is similar to that shown in FIG. 1. However, the scanner 11 as the image input section is constituted of a color scanner capable of selectively executing monochromatic image reading (input processing of monochromatic image data) and color image reading (input processing of color image). The printer 17 as the image output section is constituted of a color printer capable of selectively executing monochromatic image printing (output processing of monochromatic image) and color image printing (output processing of color image).

In the digital compound machine 1 that has the functions of processing monochromatic and color images, a program set in the DSP 12 is changed depending on whether image data to be processed is a color image or a monochromatic image. For example, in the case of monochrome copying of a document image, the program set in the DSP 12 executes preparation processing, filter processing, magnification conversion, density conversion, γ conversion, error diffusion processing (or dither processing), and the like. In the case of color copying of the document image, the program set in the DSP 12 executes preparation processing, filter processing, magnification processing, density processing, γ conversion, dither processing, and the like.

That is, when a monochrome copying operation is performed, the CPU 13 sets a program to execute image processing for monochrome copying in the DSP 12. When color copying is performed, the CPU 13 sets a program to execute image processing for color copying in the DSP 12. In other words, the CPU 13 changes the programs set in the DSP 12 to enable switching between the image processing for a monochromatic image and the image processing for a color image.

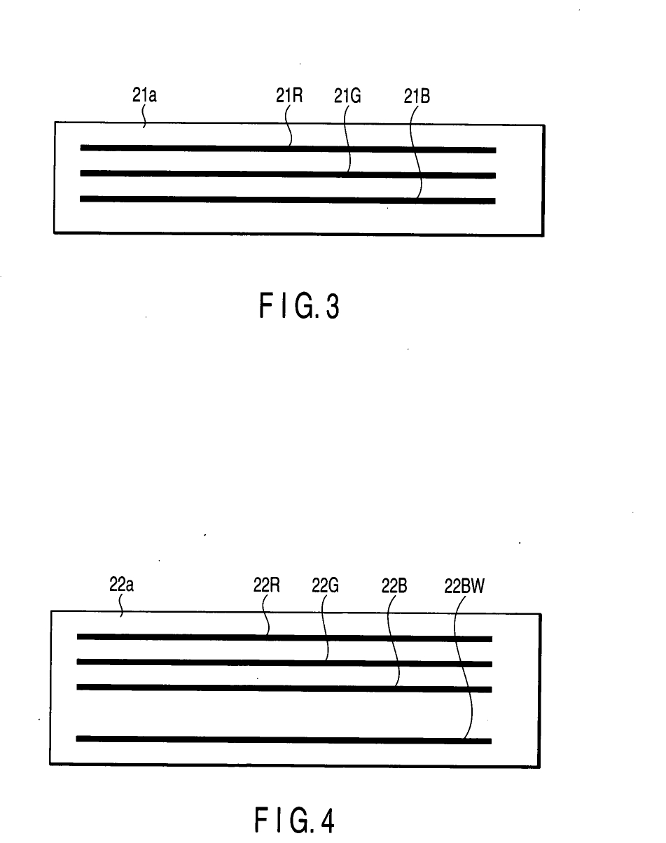

Each of FIGS. 3 and 4 shows a configuration example of the CCD sensor 11a used for the scanner (color scanner) 11. In the scanner 11 that uses the CCD sensor 11a as shown in FIGS. 3 and 4, monochromatic image reading and color image reading can be selectively carried out.

FIG. 3 shows an appearance configuration of a 3-line CCD sensor 21 used as the CCD sensor 11a of the scanner 11. FIG. 4 shows an appearance configuration of a 4-line CCD sensor 22 used as the CCD sensor 11a of the scanner 11.

First, the scanner 11 containing the 3-line CCD sensor 21 shown in FIG. 3 will be described.

The 3-line CCD sensor 21 shown in FIG. 3 is constituted of a red line CCD sensor 21R for outputting a red component (R signal), a green line CCD sensor 21G for outputting a green component (G signal), and a blue line CCD sensor 21B for outputting a blue component (B signal). Each of the line CCD sensors 21R, 21G and 21B is constituted of a photoelectric conversion element corresponding to each pixel of one line in the main scanning direction.

In the scanner 11 containing the 3-line CCD sensor 21, each pixel is converted into an electric signal indicating a density (or luminance) of each color. Accordingly, the scanner 11 including the 3-line CCD sensor 21 reads the document image as image data constituted of three signals, i.e., R, G and B signals.

Outputs of the line CCD sensors 21R, 21G and 21B are corrected (aligned) in accordance with a sub-scanning direction distance between the line CCD sensors to be output as color image data.

In the scanner 11 including the 3-line CCD sensor 21, color image reading and monochromatic image reading are selectively carried out. That is, in the case of reading a color image, the scanner 11 including the 3-line CCD sensor 21 outputs signals (R, G and B signals) from the line CCD sensors 21R, 21G and 21B as color image data.

In the case of reading a monochromatic image, the scanner 11 including the 3-line CCD sensor 21 must generate monochromatic image data from the signals (R, G and B signals) output from the line CCD sensors 21R, 21G and 21B. The processing for generating the monochromatic image data from the R, G and B signals as the output signals of the line CCD sensors 21R, 21G and 21B may be executed by a processing section (not shown) in the scanner 11.

According to the embodiment, the processing for generating the monochromatic image data from the R, G, and B signals as the output signals of the line CCD sensors 21R, 21G and 21B is executed by the DSP 12. Thus, the CPU 13 introduces a program for converting color image data into monochromatic image data to the DSP 12 to perform a monochrome copying or monochrome scanning operation.

In other words, in the digital compound machine 1 on which the scanner 11 equipped with the 3-line CCD sensor 21 is mounted, in the case of processing the image data read by the scanner 11 as a color image (in the case of a color image processing mode), the CPU 13 sets a program of image processing for the color image data constituted of the R, G and b color signals in the DSP 12. Accordingly, when the digital compound machine 1 is set in the color image processing mode, the CPU 13 can switch the DSP 12 to execute color image processing such as color copying or color scanning.

On the other hand, in the case of processing the image data read by the scanner 11 as a monochromatic image (in the case of a monochromatic image processing mode), the CPU 13 sets a program for converting the color image data constituted of the R, G and B signals into monochromatic image data, and a program for executing image processing for the monochromatic image data in the DSP 12. Accordingly, when the digital compound machine is set in the monochromatic image processing mode, the CPU 13 can switch the DSP 12 to execute monochromatic image processing such as monochrome copying or monochrome scanning.

Next, the scanner 11 including the 4-line CCD sensor 22 shown in FIG. 4 will be described.

The 4-line CCD sensor 22 shown in FIG. 4 is constituted of a red line CCD sensor 22R for outputting a red component (R signal), a green line CCD sensor 22G for outputting a green component (G signal), a blue line CCD sensor 22B for outputting a blue component (B signal), and a 3-line CCD sensor of monochrome line CCD sensors 22BW.

Each of the line CCD sensors 22R, 22G, 22B and 22BW is constituted of a photoelectric conversion element corresponding to each pixel of one line in the main scanning direction. In the scanner 11 including the 4-line CCD sensor 22, the document image is selectively read as a color image or a monochromatic images.

For example, in the case of reading the document image as a color image (in the case of a color reading mode), the scanner 11 converts each pixel of the document image into an electric signal (R, G or B signal) indicating a density (or luminance) of each color. Accordingly, the scanner 11 including the 4-line CCD sensor 22 reads the document image as color image data.

Outputs of the line CCD sensors 22R, 22G, and 22B are corrected (aligned) in accordance with a sub-scanning direction distance between the line CCD sensors. Data of the corrected outputs of the line CCD sensors 22R, 22G and 22B are output as one color image data.

In the case of reading the document image as a monochromatic image (in the case of a monochrome reading mode), the scanner 11 converts each pixel of the document image into an electric signal (RW signal) indicating a monochrome density (or luminance) by each line CCD sensor 22BW. Accordingly, the scanner 11 including the 4-line CCD sensor reads the document image as monochromatic image data.

As described above, in the case of reading the document image by color, the scanner 11 including the 4-line CCD sensor 22 outputs the signals (R, G and B signals) from the line CCD sensors 22R, 22G and 22B as the color image data. In the case of reading the document image by monochrome, the scanner 11 including the 4-line CCD sensor 22 outputs the signal (BW signal) from the line CCD sensor 22BW as the monochromatic image data.

Therefore, in the digital compound machine 1 on which the scanner 11 equipped with the 4-line CCD sensor 22 is mounted, in the case of processing the color image read by the scanner 11 (in the case of a color image processing mode), the CPU 13 sets a program of image processing for the color image data constituted of the R, G and B color signals in the DSP 12. Accordingly, in the color image processing mode, the CPU 13 can switch the DSP 12 to execute color image processing such as color copying or color scanning.

On the other hand, in the case of processing the monochromatic image read by the scanner 11 (in the case of a monochromatic image processing mode), the CPU 13 sets a program for executing image processing for the monochromatic image data in the DSP 12. Accordingly, in the monochromatic image processing mode, the CPU 13 can switch the DSP 12 to execute monochromatic image processing such as monochrome copying or monochrome scanning.

Next, description will be made of a case in which the DSP 12 performs a plurality of different image processing operations in parallel.

As described above, the DSP 12 can execute various image processing operations in accordance with the programs set by the CPU 13. The DSP 12 can execute a plurality of different image processing operations in parallel. In other words, the CPU 13 sets a plurality of programs for executing a plurality of image processing operations in the DSP 12, whereby the DSP 12 can execute the plurality of different image processing operations for the input image data.

Next, description will be made of a specific example in which the DSP 12 performs a plurality of different image processing operations.

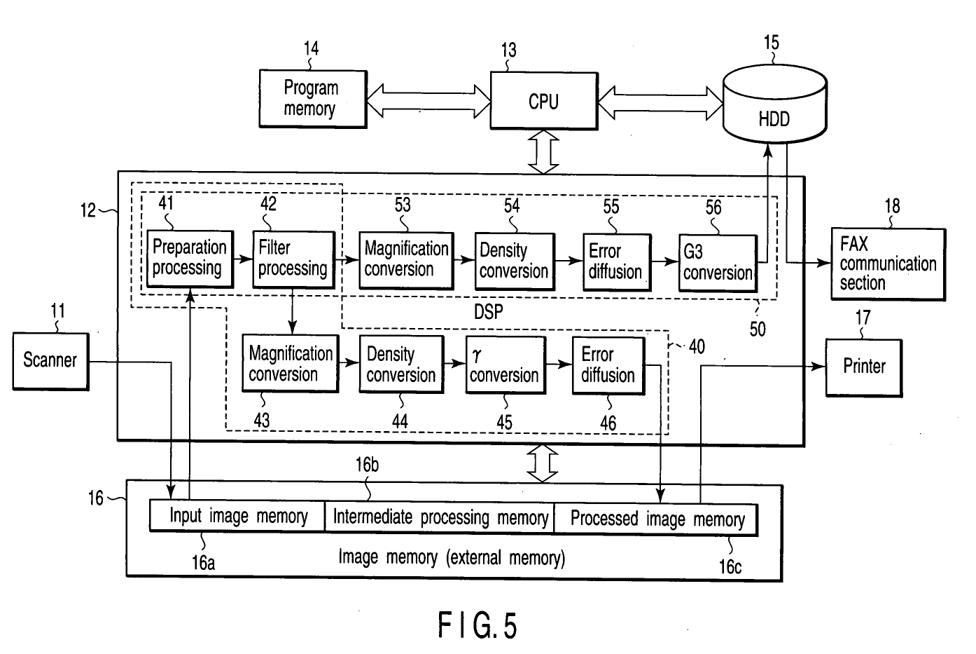

FIG. 5 illustrates an operation when the DSP 12 executes generation of image data for monochrome copying as first image processing (generation processing of monochrome print data) and generation of data for FAX transmission as second image processing (generation processing of FAX transmission data) in parallel.

When the generation processing of monochrome print data and the generation processing of FAX transmission data are executed in parallel, the CPU 13 sets a program group 40 for generating monochrome print data and a program group 50 for generating FAX transmission data in the DSP 12.

For example, as shown in FIG. 5, for the generation processing of monochrome print data, programs of preparation processing 41, filter processing 42, magnification conversion processing 43, density conversion (density adjustment) processing 44, γ conversion (γ adjustment) processing 45, error diffusion processing 46, and the like are set in the DPS 12. For the generation processing of FAX transmission data, programs of preparation processing 41, filter processing 42, magnification conversion processing 53, density conversion (density adjustment) processing 54, γ conversion (γ adjustment) processing 55, G3 conversion processing 56, and the like are set in the DSP 12.

Description will be made of an operation of the digital compound machine in a state in which the programs are set in the DSP 12.

First, the image data of the document image read by the scanner 11 is stored in the input image memory 16a via the DSP 12. Upon the storage of the image data in the input image memory 16a, the DSP 12 executes the generation processing 40 of monochrome print data as the first image processing and the generation processing 50 of FAX transmission data as the second image processing in parallel for the image data stored in the input image memory 16a.

In this case, as the first image processing, the DSP 12 sequentially executes the preparation processing 41, the filter processing 42, the magnification conversion processing 43, the density conversion (density adjustment) processing 44, the γ conversion (γ adjustment) processing 45, and the error diffusion processing 46 for the input image data stored in the input image memory 16a. The DSP 12 stores monochrome print data which is a result of the first image processing in the processed image memory 16c. As a result, the printer 17 can print an image based on the image data (monochrome print data) stored in the processed image memory 16c on a sheet.

As the second image processing, the DSP 12 sequentially executes the preparation processing 41, the filter processing 42, the magnification conversion processing 53, density conversion (density adjustment) processing 54, the γ conversion (γ adjustment) processing 55, and the G3 conversion processing 56 for the input image data stored in the input image memory 16a. The DSP 12 stores FAX transmission data which is a result of the second image processing in the HDD 15. As a result, the FAX communication section 18 can transmit the processed image data (FAX transmission data) stored in the HDD 15 to the outside through facsimile communication.

In the example shown in FIG. 5, the preparation processing 41 and the filter processing 42 are common between the generation processing of monochrome print data (first image processing) and the generation processing of FAX transmission data (second image processing). Hence, in the process of the plurality of different image processing operations, similar processing can be realized only by setting a common program in the DSP 12.

That is, by setting the aforementioned programs, the DSP 12 can simultaneously execute common processing between the generation processing of monochrome print data (first image processing) and the generation processing of FAX transmission data (second image processing). As a result, in the digital compound machine, it is possible to efficiently use processing resources of the DSP 12 and to improve performance such as shortening of a total processing time.

In other words, when the DSP 12 performs the plurality of different image processing operations, processing portions (program portions) implemented by similar processing contents and similar setting parameters in the image processing operations are set as common programs in the DSP 12. This is realized in such a manner that the CPU 13 determines programs to be made common in the plurality of image processing operations and sets the programs determined to be made common as common programs in the plurality of image processing operations in the DSP 12.

That is, when the plurality of different image processing operations are set in the DSP 12, the CPU 13 determines programs to be executed by similar processing contents and similar setting parameters in the plurality of different image processing operations executed by the DSP 12. Based on the determination, the CPU 13 sets the programs of the similar processing contents and the similar setting parameters as common programs in the plurality of different image processing operations in the DSP 12.

A combination of a variety of processing operations can be set in the DSP 12. That is, in the DSP 12, a combination of a plurality of processing operations other than the generation processing of the monochrome print data as the first image processing and the generation of FAX transmission data as the second image processing can be set.

For example, in the case of executing a color copying operation and a scanned image storing operation in parallel, it is possible to set a program for executing processing of generating color print data as first image processing and processing of generating storage data from a scanned image as second image processing in parallel in the DSP 12.

In the case of executing color image processing and monochrome image processing for the color image data in parallel, it is possible to set a program for executing processing for the color image data as first image processing, processing of converting the color image data into monochromatic image data as second image processing, and processing for a monochromatic image in parallel in the DSP 12.

As described above, in the DSP 12 in which the combination of various processing programs is set, the plurality of processing operations can be performed in parallel for the image data. For example, in the DSP 12, it is possible to set a combination of various processing programs such as image processing operations for monochrome copying and FAX transmission, image processing operations for FAX transmission and scanned image storage, image processing operations for color copying and scanned image storage, or internal processing switching by an ACS or the like.

Accordingly, in the digital compound machine including the DSP 12, it is possible to execute the plurality of processing operations for the image data read by the scanner. Moreover, in the digital compound machine having the DSP 12, it is possible to easily execute setting for executing the plurality of processing operations in parallel.

Next, description will be made of an operation of setting programs in the DSP 12.

As described above, the programs must be set in the DSP 12 before it executes image processing for the image data. Specifically, for each inputting of various buttons of the user interface 20, the CPU 13 may set an image processing program in accordance with designated processing contents. When the start key of the user interface 20 is input, i.e., when processing contents are established, the CPU 13 may set an image processing program in the DSP 12 in accordance with the established processing contents.

For example, when a program is set in the DSP 12 in accordance with inputting of various buttons of the user interface 20, there is an advantage that the program is quickly set in the DSP 12. In this case, however, if processing contents are changed before processing is actually started (before processing contents are established), the CPU 13 may need to change the set program.

On the other hand, in the case of setting a program in the DSP 12 in accordance with inputting of the start key of the user interface 20, program setting in the DSP 12 can be surely carried out. This is because processing contents to be executed have been established when the start key instructing a start of processing is input.

Now, description will be made of an operation example when the CPU 13 sets image processing program in the DSP 12 in accordance with processing contents upon an input of the start key of the user interface 20.

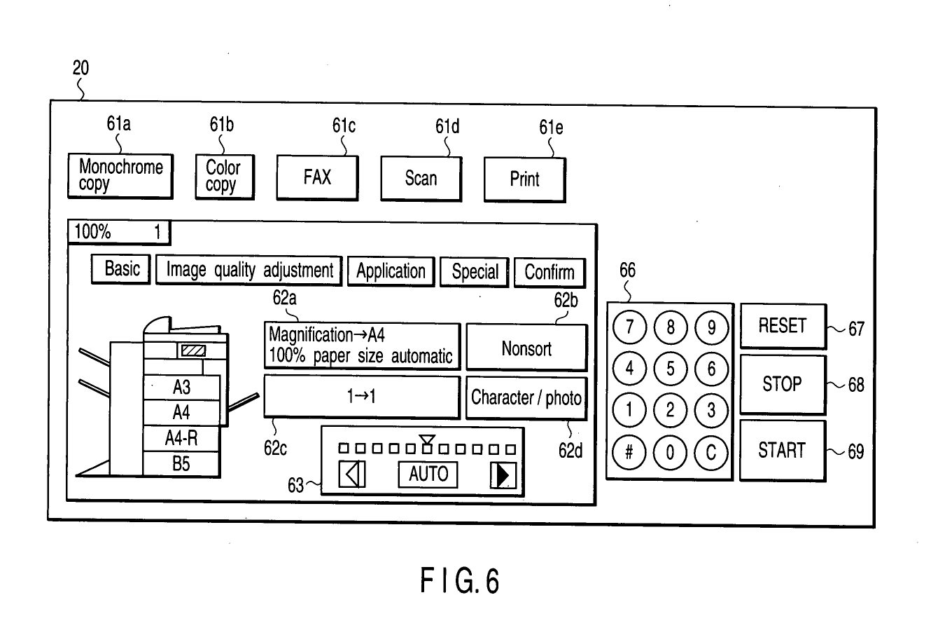

FIG. 6 shows a configuration example of the user interface 20. FIG. 6 shows the example of the user interface 20 in which various buttons are displayed in the display with the built-in touch panel.

In the example of FIG. 6, as function switching buttons, buttons such as a monochrome copy 61a, a color copy 61b, a FAX 61c, a scan 61d, and a printer 61e are displayed to be selected by the touch panel. The monochrome copy 61a is a button to instruct a copy function of a document image by a monochromatic image. The color copy 61b is a button to instruct a copy function of the document image by a color image. The FAX 61c is a button to instruct a FAX transmission function of the document image by the FAX communication section 18. The scan 61d is a button to instruct a function of reading the document image by the scanner 11 to store it as image data in the HDD 15 as storage means in the digital compound machine 1, or a function of transferring the data to the external device such as the PC 3. The printer 61e is a button to instruct a network print function for printing based on the image data received from the external device such as the PC through the network 2.

In the example of FIG. 6, selection buttons for selecting various functions, such as a copy magnification setting key 62a, a sort function setting key 62b, a print mode setting key 62c, a document image kind selection key 62d, and a density selection key 63, are displayed to be selected by the touch panel. The copy magnification setting key 62a is a button to instruct a magnification for the document image or the input image. The sort function key 62b is a button to instruct a function of processing a printing sequence of image data or a sheet as a printing result of the image data. The print mode setting key 62c is a button to instruct the number of images or the like printed on one sheet. The document image kind selection key 62d is a button to select a kind (character image or photo image) of the document image. The density selection key 63 is a button to instruct a density when the image data is printed on a sheet.

Furthermore, in the example of FIG. 6, buttons such as a ten key 66, a reset key 67, a stop key 68, and a start key 69 are displayed to be selected by the touch panel. The ten key 66 is a button to input numerals such as the number of copies. The reset key 67 is a button to instruct resetting of processing contents designated by various buttons. The stop key 68 is a button to instruct a stop of processing such as a copying operation being executed. The start key 69 is a button to instruct a start of processing, e.g., a copying operation, a FAX operation, a scanning operation, or a printing operation. The start key 69 instructs a start of processing. Accordingly, processing contents are established by inputting of the start key 69.

Next, description will be made of an operation of setting a program in the DSP 12 in accordance with the instruction input to the user interface 20.

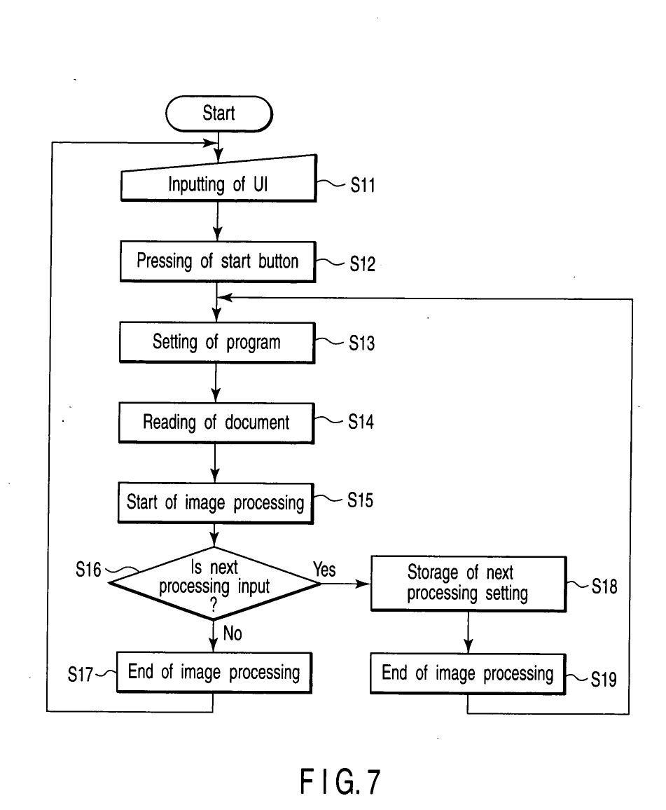

FIG. 7 is a flowchart illustrating processing for setting a program in the DSP 12.

First, in a standby state, the digital compound machine 1 receives an input of processing contents through the user interface 20 as shown in FIG. 6 (step S11). In this state, the user sets (inputs) the processing contents by various buttons of the user interface 20. Additionally, upon completion of the setting of the processing contents by various buttons of the user interface 20, the user inputs the start key 69 to instruct establishment of the processing contents and a start of processing.

Upon the input of the start key 69 of the user interface 20 (step S12), the CPU 13 determines that the processing contents set by the user interface 20 have been established. Upon the determination of the establishment of the processing contents (set contents) instructed by the user, the CPU 13 determines image processing to be executed by the DSP 12 in accordance with the processing contents.

In the network print function or a FAX reception function, processing contents are established in accordance with a processing request from the external device. In this case, the CPU 13 establishes processing contents based on the processing request received through the FAX communication section 18, and determines image processing to be executed by the DSP 12 in accordance with the processing contents.

Upon the determination of the image processing to be executed by the DSP 12, the CPU 13 selects a program corresponding to the image processing. The CPU 13 reads the selected program from the program memory 14 or the HDD 15. The CPU 13 sets the read program in the DSP 12 (step S13), whereby initial setting of the mage processing program compliant with the processing contents is completed in the DSP 12.

Upon the completion of the initial setting in the DSP 12, the CPU 13 starts scanning of the document image by the scanner 11 (step S14) as input processing of image data. The image data (input image data) of the document image read by the scanner 11 is temporarily stored in, e.g., the input image memory 16a, to complete the input processing of the image data. The DSP 12 may start processing for the input image data without waiting for completion of the input processing of the image data. The DSP 12 may process the input image data without any storage in the input image memory 16a.

Upon the completion of the input processing of the image data, the DSP 12 executes image processing for the input image data by the program set by the CPU 13 (step S15). If next processing is not set by the user interface 20 during the execution of the image processing for the input image data by the DSP 12 (NO in step S16), the CPU 13 finishes the image processing for the input image data by the DSP 12 (step S17).

When printing processing, FAX transmission processing, or transfer processing to the external device through the network is set as processing contents for the image data processed by the DSP 12, the CPU 13 executes processing by processed image data of the DSP 12. For example, in the case of executing printing processing based on the processed image data of the DSP 12, the processed image data (image data for printing) stored in the processed image memory 16c is output to the printer 17 in accordance with a synchronous signal therefrom. Accordingly, the printer 17 executes printing processing based on the image data for printing as the image data processed by the DSP 12.

Upon completion of the processing without next processing set by the user interface 20, the CPU 13 returns to the step S11 to set the digital compound machine 1 in a standby state for receiving next processing.

If next processing is set by the user interface 20 during the execution of the image processing for the input image data by the DSP 12 (YES in step S16), the CPU 13 temporarily stores the set contents as next processing contents in a memory such as a RAM (not shown) (step S18). In this case, upon completion of image processing for the input image data by the DSP 12 (step S19), the CPU 13 returns to the step S13 to set a new program (switch the program) for the DSP 12 based on the next processing contents stored in the memory.

In the processing example of the program setting in the DSP 12, when the start key 69 of the user interface 20 is input, the program setting or the like in the DSP 12 is executed in accordance with the set processing contents from the user. However, there is no input to the user interface 20 in FAX data reception processing or print data reception processing. Accordingly, in the FAX data reception processing or the print data reception processing, when FAX data or print data is received, the CPU 13 sets a program in the DSP 12. As a result, even when there is no input to the user interface 20, a setting operation similar to the aforementioned setting operation can be realized.

As described above, when the instruction of processing contents is input to the user interface, or when the data to be processed is received from the outside, the CPU 13 selects the program in accordance with the processing contents, and sets the selected program in the DSP 12. Thus, in the digital compound machine, it is possible to set flexile programs in accordance with various processing contents.

It should be noted that the program setting (program changing) is executed only after current processing is finished or progresses to permit a start of next processing. In the other states, i.e., a state in which transfer to next processing is inhibited (another program cannot be set in the DSP), the DSP 13 does not change the program.

As described above, in the DSP 12, a plurality of different processing operations (e.g., scanning, printing, FAX transmission, and the like) may be executed in parallel. In this case, if an internal processing program or parameter to be rewritten is not used for processing in the DSP 12, the unused portion can be rewritten.

Next, a memory accessing method by the DSP 12 will be described.

As described above, the DSP 12 uses the internal memory 12a or the image memory 16 as the external memory to perform various image processing operations. In the DSP 12, various image processing operations are preferably used by using the internal memory 12a for reason of high-speed processing or the like. However, when a data capacity of the internal memory 12a is not enough for image processing, the external memory 16 must be used to execute the image processing. A memory accessing method when the external memory 16 is used will be described below.

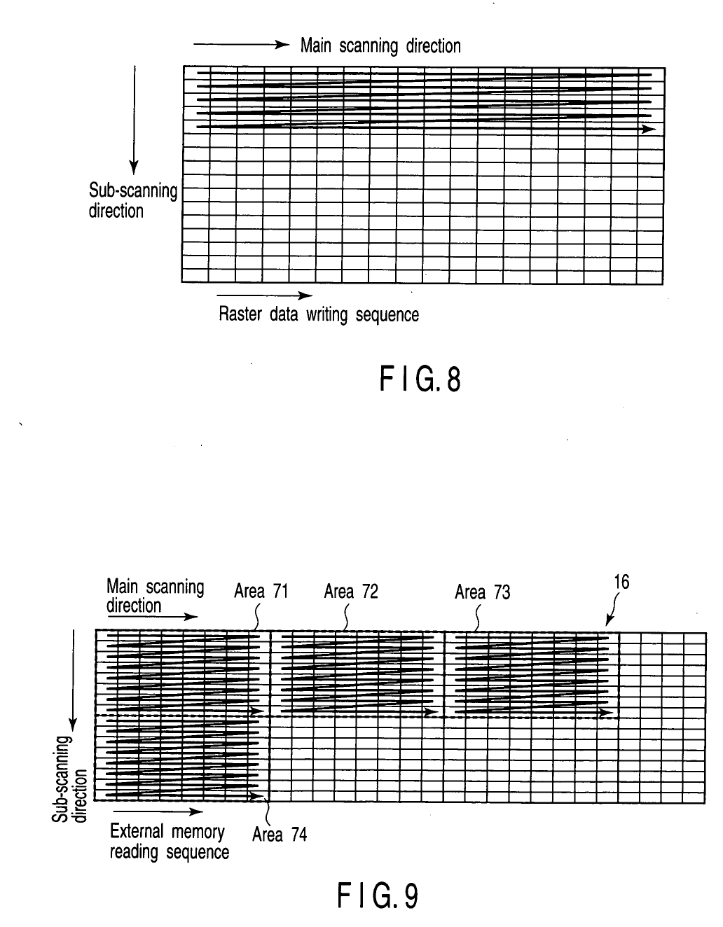

FIG. 8 shows addressing in 2-dimensional arrangement when data of a raster format is written from the scanner 11 in the memory.

Referring to FIG. 8, a memory address is represented by an X, Y coordinate system. In FIG. 8, image data of raster formats are written in input sequence, i.e., arrow sequence. That is, in FIG. 8, image data of one line in the main scanning direction are sequentially written in X coordinates, and image data of a next column (next image data of one line in the main scanning direction) are written from an initial position of the X coordinates by increasing a Y coordinate address.

For example, in the case of executing processing by referring to an image range of an N×N size such as filtering processing, in hardware (e.g., ASIC) generally used as an image processing section, it is dealt with by incorporating a line memory (internal memory constituted of RAM or the like) of main scanning N lines. In this case, for example, to execute filter processing of a 7×7 size for image data of a main scanning size 7000, necessary data capacities of the internal memory are respectively 48 k bytes for monochromatic image data and 142 k bytes for color image data.

On the other hand, a data capacity of the internal memory generally used in the DSP is small. As described above, for the program executed by the DSP 12, the internal memory 12a is preferably used for reason of high-speed processing or the like. However, a data capacity of the internal memory 12a is not enough for the processing executed by referring to the image data of a specific image range such as filter processing. In this case, the external memory 16 must be used.

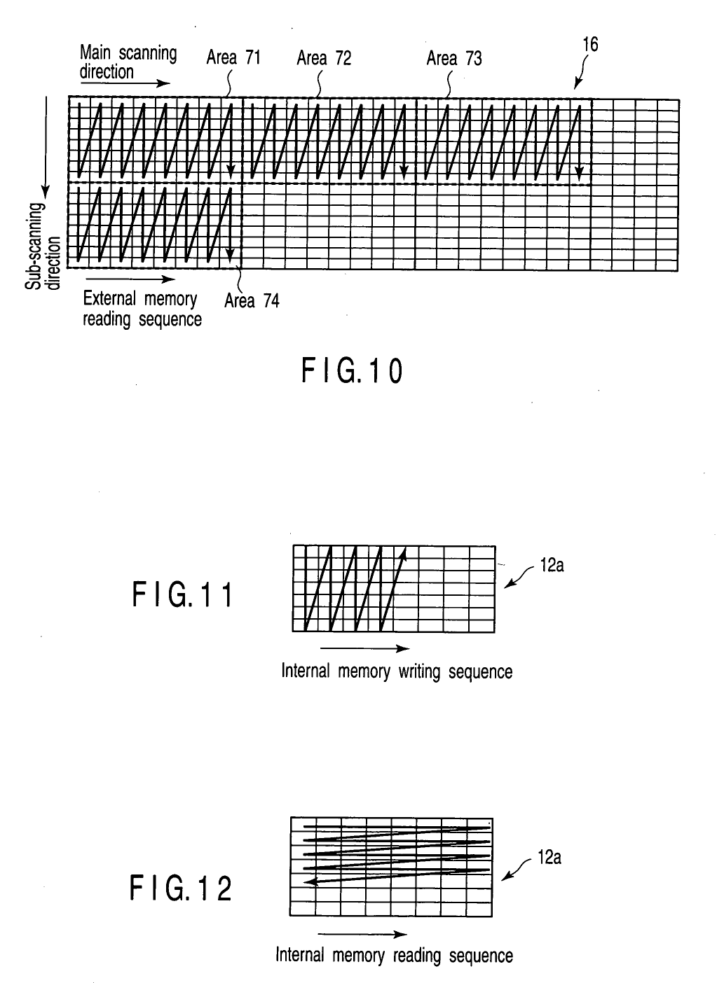

Each of FIGS. 9 and 10 shows a method of accessing the external memory 16 by the DSP 12. It is presumed here that setting of an accessing method to the external memory 16 by the DSP 12 is set by the CPU 13.

FIG. 9 shows a conversion example of a memory arrangement in the external memory 16 when the DSP 12 must refer to image data by an 8×8 unit block. As shown in FIG. 9, a case in which there is a need to refer to image data of areas 71 to 74 is presumed. For example, when the DSP 12 reads the image data of the areas from the external memory 16 in sequence of the areas 71 to 74 to execute image processing, the CPU 13 must set a controller to access the external memory 16 in the DSP 12.

To read the image data of the areas 71 to 73 shown in FIG. 9, the CPU 13 needs to set the controller to access the external memory 16 in the DSP 12 only once. However, to read the data of the area 74 shown in FIG. 9, the CPU 13 must set the controller to access the external memory 16 in the DSP 12 again. In such a case, depending on a processing time necessary for the CPU 13 to set the controller to access the external memory 16 in the DSP 12 again, image processing performance of the DSP 12 may be reduced.

FIG. 10 shows a memory accessing method different from that of FIG. 9. Areas 71 to 74 shown in FIG. 10 are the same as those of FIG. 9. That is, FIG. 10 shows the memory accessing method different from that of FIG. 9 to read data from the areas 71 to 74 of the external memory 16.

According to the memory accessing method of FIG. 10, address resetting to access the area 74 after access to the data of the areas 71 to 73 is unnecessary. In other words, according to the memory accessing method of FIG. 10, resetting of a memory access controller in the DSP 12 by the CPU 13 can be omitted. As a result, according to the memory accessing method of FIG. 10, a time necessary for resetting the memory access controller can be omitted. Hence, according to the memory accessing method of FIG. 10, it is possible to improve image processing performance in the DSP 12 more than that of FIG. 9.

However, in internal processing of the DSP 12, reference may be necessary to pixels (image signals of the pixels) constituting the image data of the areas in sequence shown in FIG. 9. In such a case, the DSP 12 must rearrange the image data read from the external memory 16 therein by the memory accessing method of FIG. 10. For such internal processing of the DSP 12, the internal memory 12a is used.

For example, it is presumed that it is no problem to assign the internal memory 12a of the DSP 12 to 64-byte image data of an 8×8 size. In this case, it is advised to select the memory accessing method of FIG. 10 for at least image data of 8×8 size (64 bytes) or less.

Generally, a method of accessing the internal memory 12a is set by describing it as a program set in the DSP 12. Accordingly, even when the CPU 13 sets the memory access controller again, the setting only needs a processing time equal to that of the internal processing of the DSP 12.

Therefore, the DSP 12 can access the data stored in the external memory 16 by the memory accessing method of FIG. 9. This is realized by the following procedure. First, the DSP 12 reads the data from the external memory 16 by the memory accessing method of FIG. 10. The DSP 12 writes the data read from the external memory 16 by the memory accessing method of FIG. 10 in the internal memory 12a in sequence shown in FIG. 11. The DSP 12 reads the data written in the internal memory 12a in the sequence of FIG. 1 in sequence shown in FIG. 12. As a result, the DSP 12 can access the data stored in the external memory 16 by the memory accessing method of FIG. 9.

Next, security of the program set in the DSP 12 will be described.

For the DSP 12 that realizes the aforementioned functions, an easily accessible DSP may be used to reduce costs of the entire image processing apparatus. In such a situation, the program set in the DSP 12 may easily be analyzed. Especially, in the image processing apparatus such as a digital compound machine, a long period and high costs are expended to develop a program for realizing image processing. Thus, contents of image processing programs employed by the digital compound machine are not disclosed in most cases. Hence, a state in which the program set in the DSP 12 can be easily read is not preferable. It is therefore not preferable to leave the image processing program in the DSP 12.

Thus, according to the digital compound machine of the embodiment, an encrypted program (program set in the DSP 12) is held in the program memory 14 or the HDD 15. According to the digital compound machine, an encrypted program (program set in the DSP 12) may be obtained from the external device such as a PC 3 through the network 2. In such a digital compound machine, it is preferable to decrypt the encrypted program in the DSP 12 and to delete the decrypted program after completion of processing in the DSP 12.

Next, a processing example of the DSP 12 by an encrypted program will be described.

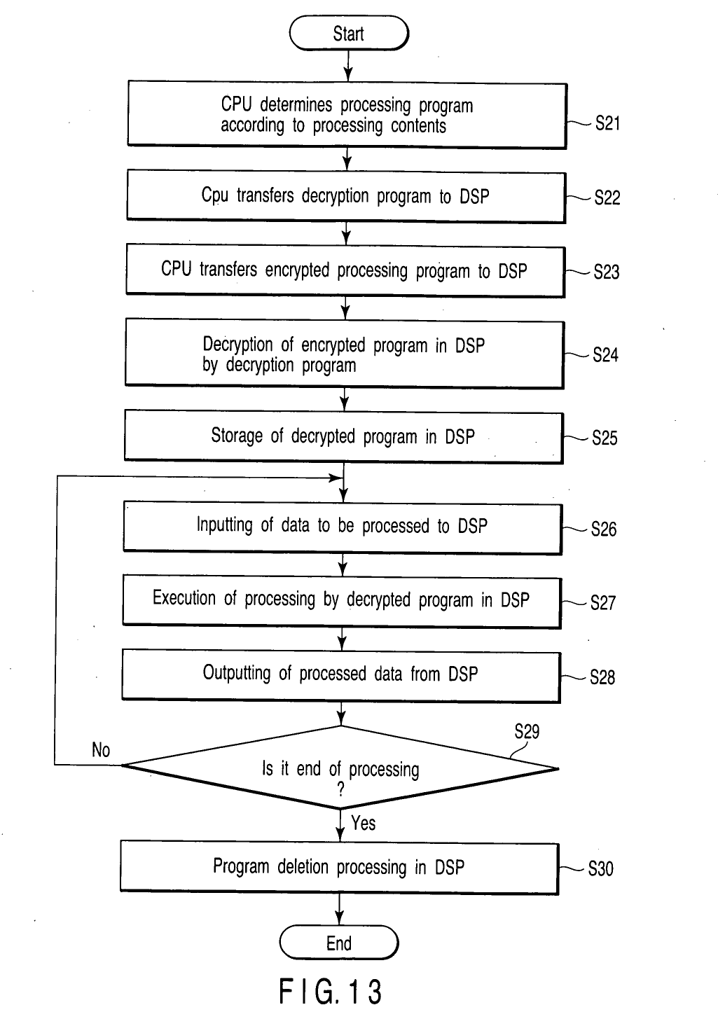

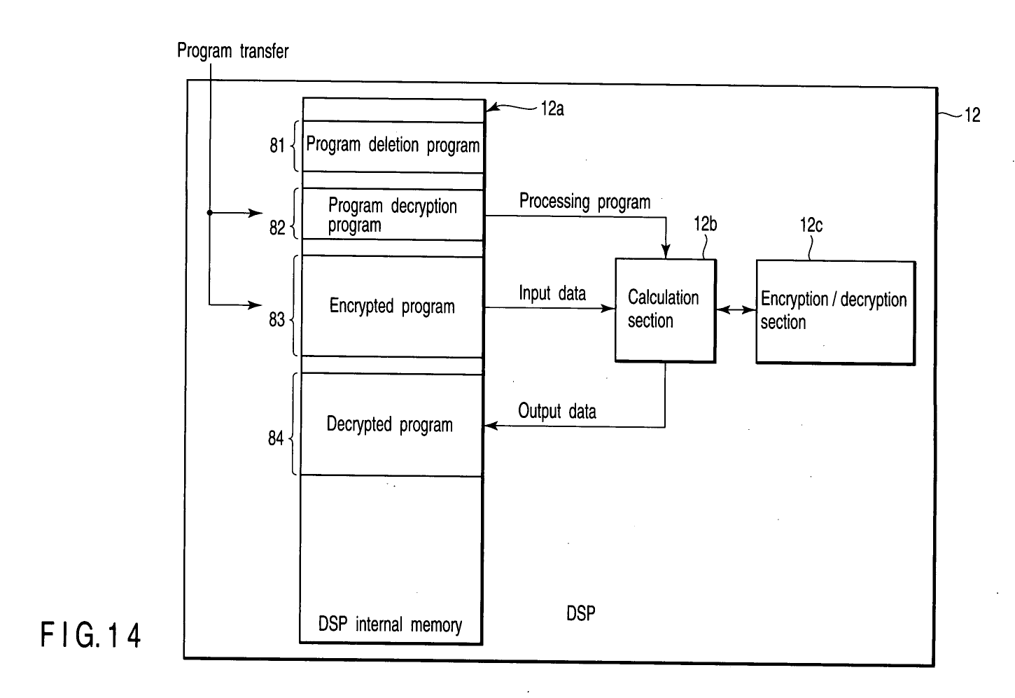

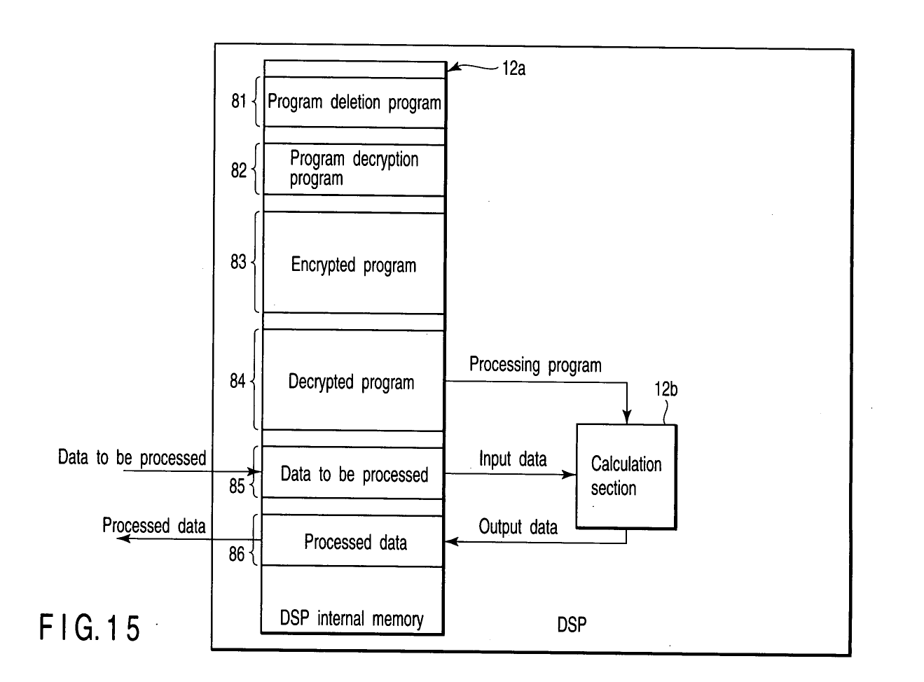

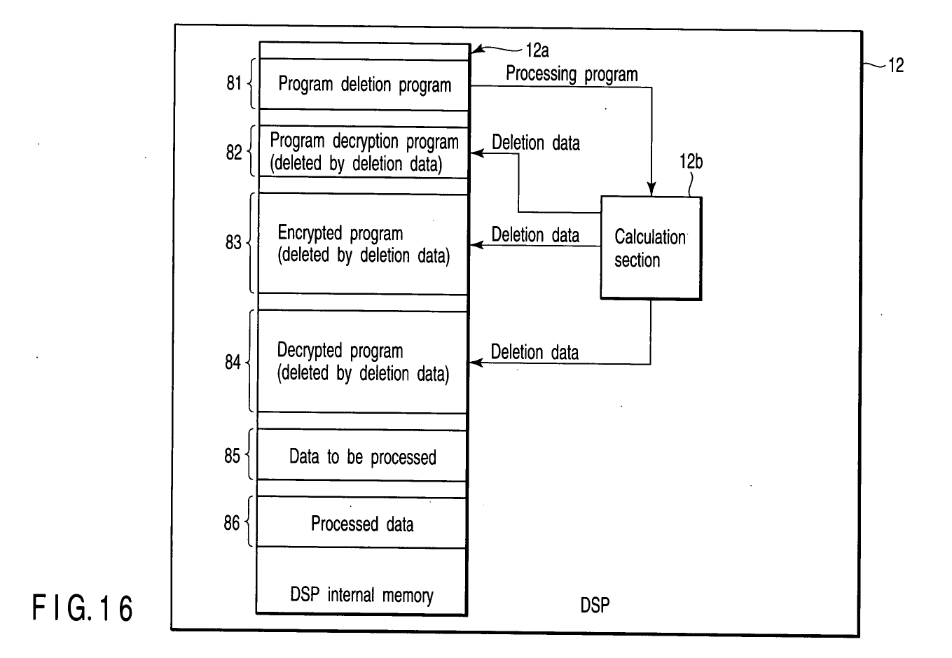

FIG. 13 is a flowchart showing an image processing example of the DSP 12 by an image processing program of an encrypted state. FIG. 14 illustrates setting of the processing program of the encrypted state in the DSP 12. FIG. 15 illustrates processing by a decrypted program in the DSP 12. FIG. 16 illustrates processing of deleting a program from the DSP 12.

To begin with, it is presumed that the image processing program to be set in the DSP 12 has been stored in its encrypted state in the program memory 14 or the HDD 15.

In this state, the CPU 13 establishes processing contents in accordance with a processing start instruction input to the user interface 20 or a processing request input from the external device through the network interface 19. Upon the establishment of processing contents, the CPU 13 decides an image processing program to be set in the DSP 12 in accordance with the processing contents (step S21). As described above, the image processing program to be set in the DSP 12 has been stored in its encrypted state in the program memory 14 or the HDD 15.

After the image processing program (encrypted program) to be set in the DSP 12 has been decided, the CPU 13 sets a decryption program to decrypt the image processing program (encrypted program) in the DSP 12 (step S22). For example, the decryption program itself may be encrypted in a state to permit its decryption by the CPU 13 alone, and stored in the program memory 14 or the like.

Upon the setting of the decryption program in the DSP 12, the CPU 13 further reads the image processing program to be executed by the DSP 12 in the encrypted state from the program memory 14 or the HDD 15, and supplies it to the DSP 12 (step S23).

Upon reception of the encrypted image processing program, the DSP 12 decrypts the received encrypted program by the decryption program set in the step S22 (step S24).

After the encrypted image processing program supplied from the CPU 13 has been decrypted, the DSP 12 sets the decrypted image processing program therein (step S25).

In the example of FIG. 14, the decryption program transferred to the DSP 12 under control of the CPU 13 is stored in an area 82 of the internal memory 12a. The program of the encrypted state transferred to the DSP 12 under control of the CPU 13 is stored in an area 83 of the internal memory 12a. In the internal memory 12a, a deletion program used for program deletion processing described below is stored in an area 81.

In the example of FIG. 14, the DSP 12 includes an encryption/decryption section 12c in addition to the internal memory 12a and the calculation section 12b. That is, in the constitutional example of FIG. 14, the encryption/decryption section 12c for executing encryption/decryption is mounted to be fixed in the DSP 12. This means that it is not necessary to transfer a program to execute encryption or decryption processing from the outside into the DSP. In this case, for the decryption program, a program to execute decryption processing itself is unnecessary. Accordingly, the decryption program only needs to be constituted of data to decrypt the encrypted program by the encryption/decryption section 12c. With this configuration, in the DSP 12 of FIG. 14, it is possible to realize high security.

In the calculation section 12b, by the decryption program stored in the area 83, all the encrypted programs (input data) stored in the area 82 can be decrypted. In other words, the encryption/decryption section 12c can be omitted from the DSP 12.

In the example of FIG. 14, the decryption program stored in the area 83 and the data (output data) decrypted by the decryption section 12c are stored as decrypted programs in the area 84. Accordingly, in the DSP 12 of FIG. 14, processing by the decrypted programs is enabled.

Through the aforementioned processing, in the DSP 12, the image processing program of the encrypted state is decrypted, and the decrypted image processing program is set. The image processing program to be set in the DSP 12 is transferred in the encrypted state from the CPU 13 to the DSP 12. As a result, it is possible to prevent leakage of the image processing program during its transfer from the CPU 13 to the DSP 12.

Upon the setting of the image processing program in the DSP 12, the CPU 13 inputs image data (image data of processing target) to be processed in the DSP 12 (step S26). The input image data to be processed is subjected to image processing by the image processing program set in the DSP 12 (step S27). The processed image data is output as processed image data (step S28). For example, the processed image data is output to the printer 17 or to the outside through the network interface 19, or stored in the memory such as the HDD 15.

For example, in the example shown in FIG. 15, in the DSP 12, the calculation section 12b executes image processing based on the decrypted program stored in the area 84 of the internal memory 12a. In the example of FIG. 15, the processing target data input to the DSP 12 is stored (buffered) in an area 85 of the internal memory 12a. The calculation section 12b processes the processing target data (input data) stored in the area 85 of the internal memory 12a based on the decrypted program stored in the area 84 of the internal memory 12a. The calculation section 12b stores (buffers) data (output data) processed by the decrypted program of the area 84 in an area 86 of the internal memory 12a. The processed data stored in the area 86 of the internal memory 12a is output to the outside of the DSP 12.

The CPU 13 makes determination as to an end of image processing by the image processing program set in the DSP 12 (step S29). If the end of the image processing is determined (YES in step S29), the DSP 12 executes program deletion processing (step S30).

In this program deletion processing, the decryption program, the encrypted program, and the program decrypted by the decryption program are deleted. In the program deletion processing, the decryption program and the decrypted program may be deleted. In the program deletion processing, if a possibility that the encrypted program will be decrypted by a third party is small, the decrypted program alone may be deleted.

In the program deletion program, for example, the programs to be deleted (decryption program, encrypted program, and decrypted program) are overwritten by deletion data to be deleted. In the program deletion processing, the programs may be overwritten by new programs (programs used for next processing) to be deleted.

For example, in the example shown in FIG. 16, in the DSP 12, the calculation section 12b executes processing to delete the decryption program, the encrypted program, and the decrypted program based on a deletion program stored in the area 81 of the internal memory 12a. That is, in the example of FIG. 16, upon the end of processing by the decrypted program, the calculation section 12b deletes the programs stored in the areas 82 to 84 based on the deletion program stored in the area 81 of the internal memory 12a.

In the example of FIG. 16, the deletion program stored in the area 81 overwrites the programs of the areas 82 to 84 by the deletion program to delete them. Accordingly, the calculation section 12b writes the deletion data in the areas 83 and 84 based on the deletion program stored in the area 81. As a result, in the DSP 12, the decryption program stored in the area 82 of the internal memory 12a, the encrypted program stored in the area 83 of the internal area 12a, and the decrypted program stored in the area 84 of the internal memory 12a are deleted.

In the program deletion processing, in the DSP 12, the image processing program and the decryption program to decrypt the encrypted program can be prevented from being left. Accordingly, it is possible to prevent leakage of the image processing program and the decryption program from the DSP 12.

In the aforementioned operation example, the digital compound machine encrypts the program to be set in the DSP 12, and the DSP itself decrypts and sets the encrypted program, and deletes the program after its use. As a result, it is possible to prevent leakage of the image processing program during its transfer from the CPU 13 to the DSP 12 and leakage of the image processing program from the DSP 12.

As described above, according to the digital compound machine of the embodiment, the processing program to be executed is selected in accordance with the processing contents, and the selected program is set in the DSP used as the processing section. Hence, in the digital compound machine, the processing to be executed can be properly switched in accordance with processing contents or the like. As a result, efficient image processing can be realized in the digital compound machine. Moreover, by employing the DSP as the hardware to realize the processing section for data processing, it is possible to provide a low-cost, multifunctional, and flexible digital compound machine.

According to the digital compound machine, as the image processing section to execute image processing or data conversion processing in the apparatus, the DSP is applied in which the program for image processing or data conversion processing can be set by the control section such as a CPU. Hence, according to the embodiment, it is possible to provide an image processing apparatus such as a flexible digital compound machine on which latest image processing can be easily mounted at low costs (with smaller hardware configuration).

In the DSP, various image processing operations are realized by the programs (software) properly set from the CPU. Thus, after manufacturing of the image processing apparatus such as a digital compound machine, it is possible to easily deal with version-up of the image processing program or the like even after product shipment in accordance with a market demand or user's claim.

The image input section to input the image data to be processed by the DSP 12 is not limited to the scanner 11, but it may be an interface for receiving the image data.

For example, as the image input section, in addition to the network interface 19 or the FAX communication section 18, an interface of a high-speed data transfer bus such as a PCI bus or PCI_EXPRES can be used. Moreover, when the image data input by such an image input section is data of a raster format, in the DSP 12, image processing (processing of converting raster data into block data) using the external memory 16 is enabled.

Furthermore, the image output section to output the image data processed by the DSP 12 is not limited to the printer 17, but it may be an interface to output the image data to the outside. For example, as the image output section, in addition to the FAX communication section 18 or the network interface 19, an interface of a high-speed transfer bus such as a PCI bus or PCI EXPRES or an image output VIDEO bus can be used. The image data processed by the DSP 12 may be stored in the HDD 15. In this case, the interface (not shown) for outputting the image data from the DSP 12 to the HDD 15 functions as the image output section.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image processing apparatus comprising:
an image input section which inputs image data;
a control section which selects image processing program to be executed for the image data input by the image input section; and
a digital signal processing section in which the program selected by the control section is set and which processes the image data input by the image input section by the set program.

2. The image processing apparatus according to claim 1, further comprising an image forming section which forms an image in an image forming medium based on the image data processed by the digital signal processing section.

3. The image processing apparatus according to claim 1, further comprising an interface which outputs the image data processed by the digital signal processing section to the outside.

4. The image processing apparatus according to claim 1, further comprising a memory which stores the image data processed by the digital signal processing section.

5. The image processing apparatus according to claim 1, wherein the digital signal processing section is a digital signal processor constituted of a programmable processing chip.

6. The image processing apparatus according to claim 1, further comprising a memory which stores various image processing programs to be set in the digital signal processing section,
wherein the control section selects a program of image processing to be executed for the image data input by the image input section from the programs stored in the memory.

7. The image processing section according to claim 1, wherein the image input section is a scanner to convert a document image into image data.

8. The image processing section according to claim 1, wherein:
the image input section is a scanner provided with photoelectric conversion means capable of inputting a plurality of color signals as color image data; and
the control section sets a program to convert color image data into monochromatic image data when the color image data read by the scanner is processed as a monochromatic image.

9. The image processing apparatus according to claim 1, wherein:
the image input section is a scanner provided with a photoelectric conversion section capable of inputting color image data constituted of a plurality of color signals and monochromatic image data constituted of monochromatic signals; and
the control section selects an image processing program for a color image when the color image data input by the scanner is processed, and an image processing program for a monochromatic image when the monochromatic image data input by the scanner is processed.

10. The image processing apparatus according to claim 1, wherein:
the control section selects a plurality of programs to execute a plurality of image processing operations for the image data input by the image input section; and
the digital signal processing section has the plurality of programs selected by the control section set therein, and executes the plurality of image processing operations in parallel for the image data input by the image input section by the programs.

11. The image processing apparatus according to claim 10, wherein:
the control section selects programs to execute first image processing and second image processing when the first image processing and the second image processing are executed for the image data input by the image input section; and
the digital signal processing section has the plurality of programs selected by the control section set therein, and executes the first image processing and the second image processing in parallel for the image data input by the image input section by the programs.

12. The image processing apparatus according to claim 11, wherein in the digital signal processing section, one and the same program is set as a common program for the programs to execute the first image processing and the second image processing.

13. The image processing apparatus according to claim 10, further comprising an image forming section to form an image in an image forming medium based on the image data processed by the digital signal processing section, and an interface to output the image data processed by the digital signal processing section to the outside, wherein:
the control section selects programs to execute first image processing and second image processing when the first image processing and the second image processing are executed respectively to generate image data for image formation by the image forming section and image data to be output to the outside by the interface; and
the digital signal processing section has the plurality of programs selected by the control section set therein, and executes the first image processing and the second image processing in parallel for the image data input by the image input section by the programs.

14. The image processing apparatus according to claim 1, further comprising a user interface to which processing contents are input,
wherein the control section selects a program to execute image processing in accordance with the processing contents input by the user interface.

15. The image processing apparatus according to claim 1, further comprising a user interface to which processing contents are input, and a start button to instruct a start of processing of contents input by the user interface,
wherein the control section selects a program to execute image processing in accordance with the processing contents input by the user interface when the start of the processing is input by the start button.

16. The image processing apparatus according to claim 1, wherein:
the image input section is an interface to receive image data from an external device and control data indicating processing contents for the image data; and
the control section selects a program to execute image processing in accordance with the processing contents based on the control data received from the external device by the interface.

17. The image processing apparatus according to claim 1, further comprising a memory to be accessed by the digital signal processing section,
wherein the digital signal processing section converts image data of a raster format input by the image input section into block data by using the memory when image processing is executed by a block unit.

18. The image processing apparatus according to claim 1, wherein:
the control section sets a decryption program to decrypt a program of an encrypted state in the digital signal processing section when the program of the encrypted state is selected; and
the digital signal processing section decrypts the program of the encrypted state selected by the control section by using the decryption program set by the control section, and sets the decrypted program.

19. The image processing apparatus according to claim 18, wherein the digital signal processing section deletes the decryption program after the decryption of the program of the encrypted program.

20. The image processing apparatus according to claim 18, wherein the digital signal processing section deletes the decrypted program after execution of image processing.

21. The image processing apparatus according to claim 18, wherein the digital signal processing section executes a deletion program to delete the decrypted program after execution of image processing.

22. The image processing apparatus according to claim 18, wherein:
the digital signal processing section further comprises a decryption section to decrypt the program of the encrypted program; and
the decryption program set by the control section decrypts the program of the encrypted state by using the decryption section.

23. The image processing apparatus according to claim 19, wherein:
the digital signal processing section further comprises a decryption section to decrypt the program of the encrypted state; and
the decryption program set by the control section decrypts the program of the encrypted state by using the decryption section.

24. The image processing apparatus according to claim 20, wherein:
the digital signal processing section further comprises a decryption section to decrypt the program of the encrypted state; and
the decryption program set by the control section decrypts the program of the encrypted state by using the decryption section.

25. The image processing apparatus according to claim 21, wherein:
the digital signal processing section further comprises a decryption section to decrypt the program of the encrypted state; and
the decryption program set by the control section decrypts the program of the encrypted state by using the decryption section.
